(19) United States
(12) Patent Application Publication
(10) Pub. No.: US 2025/0105367 A1
(43) Pub. Date: Mar. 27, 2025

(54) SECONDARY BATTERY, METHOD OF MANUFACTURING THE SAME, AND BATTERY PACK

(71) Applicant: MURATA MANUFACTURING CO., LTD., Kyoto (JP)

(72) Inventor: Akira SHINKAWA, Kyoto (JP)

(21) Appl. No.: 18/975,404

(22) Filed: Dec. 10, 2024

Related U.S. Application Data
(63) Continuation of application No. PCT/JP2023/032222, filed on Sep. 4, 2023.

(30) Foreign Application Priority Data
Sep. 29, 2022 (JP) 2022-157064

(51) Int. Cl. H01M 10/0587; H01M 4/02; H01M 4/04; H01M 4/131; H01M 4/133; H01M 4/1391; H01M 4/1393; H01M 4/66; H01M 10/0525; H01M 50/533; H01M 50/534; H01M 50/536

(52) U.S. Cl. CPC H01M 10/0587; H01M 4/0404; H01M 4/131; H01M 4/133; H01M 4/1391; H01M 4/1393; H01M 4/661; H01M 4/662; H01M 10/0525; H01M 50/533; H01M 50/534; H01M 50/536; H01M 2004/027; H01M 2004/028

(57) ABSTRACT

A secondary battery having higher reliability is provided. The secondary battery includes an electrode wound body, a first electrode current collector plate, and a second electrode current collector plate. The electrode wound body includes a stacked body including a first electrode and a second electrode that are stacked with a separator interposed therebetween. The stacked body is wound around a central axis extending in a first direction. The electrode wound body includes a first end face and a second end face that are opposed to each other in the first direction. The first electrode current collector plate faces the first end face of the electrode wound body and is coupled to the first electrode. The second electrode current collector plate faces the second end face of the electrode wound body and is coupled to the second electrode. The first electrode includes a first electrode covered region in which a first electrode current collector is covered with a first electrode active material layer, and a first electrode exposed region in which the first electrode current collector is exposed without being covered with the first electrode active material layer. The first electrode exposed region includes multiple first edge parts that are adjacent to each other in a radial direction of the electrode wound body. The multiple first edge parts are bent toward the central axis and overlap each other to form the first end face. The multiple first edge parts each have an end including a first curved face.

### CROSS REFERENCE TO RELATED APPLICATIONS

The present application is a continuation of International Application No. PCT/JP2023/032222, filed on Sep. 4, 2023, which claims priority to Japanese Patent Application No. 2022-157064, filed on Sep. 29, 2022, the entire contents of which are incorporated herein by reference.

### BACKGROUND

The present disclosure relates to a secondary battery, a method of manufacturing the secondary battery, and a battery pack including the secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolyte that are contained inside an outer package member. A configuration of the secondary battery has been considered in various ways.

A secondary battery is proposed in which what is called a tabless structure is employed to thereby reduce an internal resistance and to allow for charging and discharging with a relatively large current.

### SUMMARY

The present disclosure relates to a secondary battery, a method of manufacturing the secondary battery, and a battery pack including the secondary battery.

Consideration has been given in various ways to improve performance of a secondary battery. However, there is still room for improvement in performance of the secondary battery.

A secondary battery having higher performance is therefore desired.

A secondary battery according to an embodiment of the present disclosure includes an electrode wound body, a first electrode current collector plate, and a second electrode current collector plate. The electrode wound body includes a stacked body including a first electrode and a second electrode that are stacked with a separator interposed between the first electrode and the second electrode. The stacked body is wound around a central axis extending in a first direction. The electrode wound body includes a first end face and a second end face that are opposed to each other in the first direction. The first electrode current collector plate faces the first end face of the electrode wound body and is coupled to the first electrode. The second electrode current collector plate faces the second end face of the electrode wound body and is coupled to the second electrode. The first electrode includes a first electrode covered region in which a first electrode current collector is covered with a first electrode active material layer, and a first electrode exposed region in which the first electrode current collector is exposed without being covered with the first electrode active material layer. The first electrode exposed region includes multiple first edge parts that are adjacent to each other in a radial direction of the electrode wound body. The multiple first edge parts are bent toward the central axis and overlap each other to form the first end face. The multiple first edge parts each have an end including a first curved face.

The secondary battery according to an embodiment of the present disclosure enhances closeness of contact between the multiple first edge parts of the first electrode current collector and the first electrode current collector plate to achieve a favorable joined state, without causing deformation of the electrode wound body. This allows for a reduced internal resistance and accordingly, a higher output.

Note that effects of the present disclosure are not necessarily limited to those described above and may include any of a series of effects described below in relation to the present disclosure.

### BRIEF DESCRIPTION OF THE FIGURES

FIG. 1 is a sectional diagram illustrating a configuration of a secondary battery according to an embodiment of the present disclosure.

FIG. 2 is a schematic diagram illustrating a configuration example of a stacked body including a positive electrode, a negative electrode, and a separator illustrated in FIG. 1.

FIG. 3 is a sectional diagram illustrating a configuration example of a sectional structure of an electrode wound body illustrated in FIG. 1.

FIG. 4A is a developed view of the positive electrode illustrated in FIG. 1.

FIG. 4B is a sectional view of the positive electrode illustrated in FIG. 1.

FIG. 4C is an enlarged sectional diagram illustrating an enlarged view of positive electrode edge parts each illustrated in FIG. 1.

FIG. 5A is a developed view of the negative electrode illustrated in FIG. 1.

FIG. 5B is a sectional view of the negative electrode illustrated in FIG. 1.

FIG. 5C is an enlarged sectional diagram illustrating an enlarged view of negative electrode edge parts each illustrated in FIG. 1.

FIG. 6A is a plan view of a positive electrode current collector plate illustrated in FIG. 1.

FIG. 6B is a plan view of a negative electrode current collector plate illustrated in FIG. 1.

FIG. 7 is a perspective diagram describing a process of manufacturing the secondary battery illustrated in FIG. 1.

FIG. 8A is a schematic diagram illustrating a step of cutting a positive electrode current collector in the process of manufacturing the secondary battery of FIG. 7.

FIG. 8B is a schematic diagram illustrating an enlarged view of a cut surface of the positive electrode current collector having been cut in the step of FIG. 8A.

FIG. 9A is a schematic diagram illustrating a step of cutting a negative electrode current collector in the process of manufacturing the secondary battery of FIG. 7.

FIG. 9B is a schematic diagram illustrating an enlarged view of a cut surface of the negative electrode current collector having been cut in the step of FIG. 9A.

FIG. 10 is a block diagram illustrating a circuit configuration of a battery pack to which the secondary battery according to an embodiment of the present disclosure is applied.

FIG. 11A is an enlarged sectional diagram illustrating an enlarged view of positive electrode edge parts of Comparative Example 1.

FIG. 11B is an enlarged sectional diagram illustrating an enlarged view of negative electrode edge parts of Comparative Example 1.

### DETAILED DESCRIPTION

The present disclosure is described below in further detail including with reference to the drawings according to an embodiment.

A secondary battery having a positive electrode terminal (a positive electrode tab) and a negative electrode terminal (a negative electrode tab) for current extraction has been widely used. The positive electrode terminal and the negative electrode terminal are respectively coupled electrically to a positive electrode and a negative electrode, which are components of a battery device. Such a secondary battery is herein referred to as a secondary battery of a tab structure. In the secondary battery of the tab structure, however, the positive electrode terminal and the negative electrode terminal each typically have a long slender strip shape, and therefore a coupling part of the positive electrode terminal to be coupled to the positive electrode and a coupling part of the negative electrode terminal to be coupled to the negative electrode are small in area. Accordingly, electrical resistance is high at each of those coupling parts, which can result in an increased internal resistance of the battery. In recent years, there has been a demand for charging and discharging at a higher load rate. In the secondary battery of the tab structure, however, due to the high internal resistance, a temperature inside the battery easily rises if charging is performed at a high load rate.

To address this, the Applicant has developed a secondary battery having what is called a tabless structure that includes no electrode terminal (tab) to be coupled to the positive electrode or the negative electrode of the battery device (for example, see International Publication No. WO 2021/020237). In the secondary battery of the tabless structure, a positive electrode current collector plate and a negative electrode current collector plate are used instead of the positive electrode tab and the negative electrode tab, and the positive electrode current collector plate and the negative electrode current collector plate are respectively coupled to the positive electrode and the negative electrode of the battery device, each in a larger contact area. Accordingly, as compared with the secondary battery of the tab structure, the secondary battery of the tabless structure achieves a greatly reduced internal resistance and allows for charging and discharging with a relatively large current.

As described above, the secondary battery of the tabless structure has a feature that the internal resistance is greatly reduced as compared with the secondary battery of the tab structure, which makes it possible to suppress a rise in temperature of the battery at the time of charging at a high load rate. The Applicant has proceeded with further studies, which have led the Applicant to propose a secondary battery of the tabless structure that makes it possible to achieve further reduction in internal resistance. Such a secondary battery will be described in detail below according to an embodiment.

A description is given first of a secondary battery according to an embodiment of the present disclosure.

In an embodiment, a cylindrical lithium-ion secondary battery having an outer appearance of a cylindrical shape will be described as an example. However, the secondary battery of the present disclosure is not limited to the cylindrical lithium-ion secondary battery, and may be a lithium-ion secondary battery having an outer appearance of a shape other than the cylindrical shape, or may be a battery in which an electrode reactant other than lithium is used.

Although a charge and discharge principle of the secondary battery is not particularly limited, the following description deals with a case where a battery capacity is obtained through insertion and extraction of the electrode reactant. The secondary battery includes a positive electrode, a negative electrode, and an electrolyte. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode.

Although not particularly limited in kind as described above, the electrode reactant is specifically a light metal such as an alkali metal or an alkaline earth metal. Examples of the alkali metal include lithium, sodium, and potassium. Examples of the alkaline earth metal include beryllium, magnesium, and calcium.

In the following, described as an example is a case where the electrode reactant is lithium. A secondary battery in which the battery capacity is obtained through insertion and extraction of lithium is what is called a lithium-ion secondary battery. In the lithium-ion secondary battery, lithium is inserted and extracted in an ionic state.

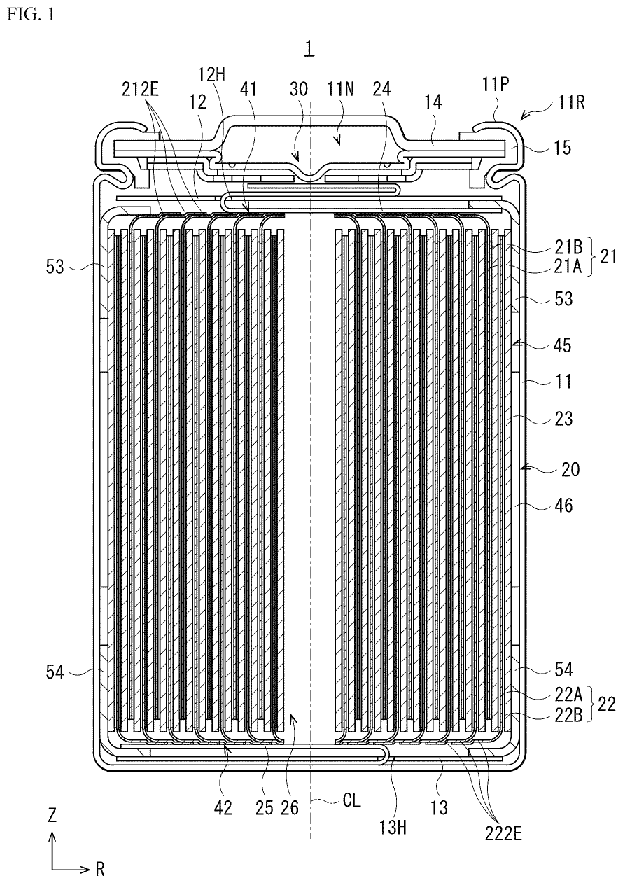

FIG. 1 illustrates a sectional configuration of a lithium-ion secondary battery 1 (hereinafter simply referred to as a secondary battery 1) according to an embodiment along a height direction. In the secondary battery 1 illustrated in FIG. 1, an electrode wound body 20 as a battery device is contained inside an outer package can 11 having a cylindrical shape.

Specifically, the secondary battery 1 includes, inside the outer package can 11, a pair of insulating plates 12 and 13, the electrode wound body 20, a positive electrode current collector plate 24, and a negative electrode current collector plate 25, for example. The electrode wound body 20 is a structure in which a positive electrode 21 and a negative electrode 22 are stacked with a separator 23 interposed therebetween and are wound, for example. The electrode wound body 20 is impregnated with an electrolytic solution. The electrolytic solution is a liquid electrolyte. Note that the secondary battery 1 may further include a thermosensitive resistive (PTC) device, a reinforcing member, or both inside the outer package can 11.

The outer package can 11 has, for example, a hollow cylindrical structure with a lower end part and an upper end part in a Z-axis direction. The Z-axis direction is the height direction. The lower end part is closed, and the upper end part is open. Accordingly, the upper end part of the outer package can 11 is an open end part 11N. The outer package can 11 includes, for example, a metal material such as iron as a constituent material. Note that a surface of the outer package can 11 may be plated with, for example, a metal material such as nickel. The insulating plate 12 and the insulating plate 13 are so opposed to each other as to allow the electrode wound body 20 to be interposed therebetween in the Z-axis direction, for example. Note that in the present specification, the open end part 11N and the vicinity thereof in the Z-axis direction may be referred to as an upper part of the secondary battery 1, and a region where the outer package can 11 is closed and the vicinity thereof in the Z-axis direction may be referred to as a lower part of the secondary battery 1.

Each of the insulating plates 12 and 13 is, for example, a dish-shaped plate having a surface perpendicular to a central axis CL of the electrode wound body 20, that is, a surface perpendicular to a Z-axis in FIG. 1. The insulating plates 12 and 13 are so disposed as to allow the electrode wound body 20 to be interposed therebetween.

For example, a structure in which a battery cover 14 and a safety valve mechanism 30 are crimped with a gasket 15 interposed therebetween, that is, a crimped structure 11R, is provided at the open end part 11N of the outer package can 11. The outer package can 11 is sealed by the battery cover 14, with the electrode wound body 20 and other components being contained inside the outer package can 11. The crimped structure 11R is what is called a crimp structure, and includes a bent part 11P serving as what is called a crimped part.

The battery cover 14 is a closing member that mainly closes the open end part 11N of the outer package can 11 in a state where the electrode wound body 20 and other components are contained inside the outer package can 11. The battery cover 14 includes a material similar to the material included in the outer package can 11, for example. A middle region of the battery cover 14 protrudes upward, i.e., in a +Z direction, for example. As a result, a peripheral region, i.e., a region other than the middle region, of the battery cover 14 is in a state of being in contact with the safety valve mechanism 30, for example.

The gasket 15 is a sealing member interposed mainly between the bent part 11P of the outer package can 11 and the battery cover 14. The gasket 15 seals a gap between the bent part 11P and the battery cover 14. Note that a surface of the gasket 15 may be coated with, for example, asphalt. The gasket 15 includes any one or more of insulating materials, for example. The insulating material is not particularly limited in kind, and examples thereof include a polymer material such as polybutylene terephthalate (PBT) or polypropylene (PP). In particular, the insulating material is preferably polybutylene terephthalate. One reason for this is that this allows the gap between the bent part 11P and the battery cover 14 to be sufficiently sealed, with the outer package can 11 and the battery cover 14 being electrically separated from each other.

The safety valve mechanism 30 is adapted to cancel the sealed state of the outer package can 11 to thereby release a pressure inside the outer package can 11, i.e., an internal pressure of the outer package can 11 on an as-needed basis, mainly upon an increase in the internal pressure. Examples of a cause of the increase in the internal pressure of the outer package can 11 include a gas generated due to a decomposition reaction of the electrolytic solution upon charging and discharging. The internal pressure of the outer package can 11 can also increase due to heating from outside.

The electrode wound body 20 is a power generation device that causes charging and discharging reactions to proceed, and is contained inside the outer package can 11. The electrode wound body 20 includes the positive electrode 21, the negative electrode 22, the separator 23, and the electrolytic solution as a liquid electrolyte.

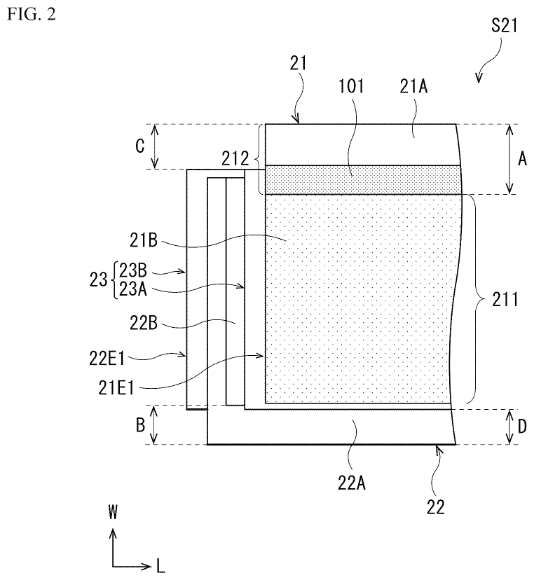

FIG. 2 is a developed view of the electrode wound body 20, and schematically illustrates a portion of a stacked body S20 including the positive electrode 21, the negative electrode 22, and the separator 23. In the stacked body S20 that corresponds to the electrode wound body 20 in an unwound state, the positive electrode 21 and the negative electrode 22 are stacked on each other with the separator 23 interposed therebetween. The separator 23 includes, for example, two bases, that is, a first separator member 23A and a second separator member 23B. Accordingly, the electrode wound body 20 includes the stacked body S20 that is four-layered. In the four-layered stacked body S20, the positive electrode 21, the first separator member 23A, the negative electrode 22, and the second separator member 23B are stacked in order. Each of the positive electrode 21, the first separator member 23A, the negative electrode 22, and the second separator member 23B is a substantially band-shaped member in which a W-axis direction corresponds to a transverse direction and an L-axis direction corresponds to a longitudinal direction.

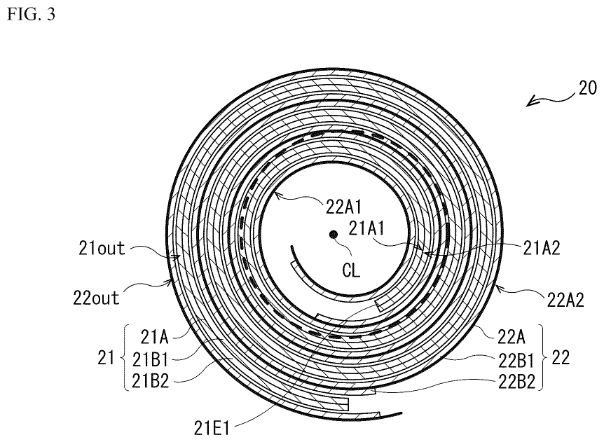

As illustrated in FIG. 3, the electrode wound body 20 includes the stacked body S20 that is so wound around the central axis CL extending in the Z-axis direction (see FIG. 1) as to form a spiral shape in a horizontal section orthogonal to the Z-axis direction. Here, the stacked body S20 is wound in an orientation in which the W-axis direction substantially coincides with the Z-axis direction. Note that FIG. 3 illustrates a configuration example of the electrode wound body 20 along the horizontal section orthogonal to the Z-axis direction. Note that, for higher visibility, FIG. 3 omits illustration of the separator 23. The electrode wound body 20 has an outer appearance of a substantially circular columnar shape as a whole. The positive electrode 21 and the negative electrode 22 are wound, remaining in a state of being opposed to each other with the separator 23 interposed therebetween. The electrode wound body 20 has a through hole 26 as an internal space at a center thereof. The through hole 26 is a hole into which a winding core for assembling the electrode wound body 20 and an electrode rod for welding are each to be put.

The positive electrode 21, the negative electrode 22, and the separator 23 are so wound that the separator 23 is positioned in each of an outermost wind of the electrode wound body 20 and an innermost wind of the electrode wound body 20. Further, in the outermost wind of the electrode wound body 20, the negative electrode 22 is positioned on an outer side relative to the positive electrode 21. In other words, as illustrated in FIG. 3, an outermost positive electrode wind part 21 out that is positioned in an outermost wind of the positive electrode 21 included in the electrode wound body 20 is positioned on an inner side relative to an outermost negative electrode wind part 22 out that is positioned in an outermost wind of the negative electrode 22 included in the electrode wound body 20. Here, the outermost positive electrode wind part 21 out is a part corresponding to the outermost one wind of the positive electrode 21 in the electrode wound body 20. The outermost negative electrode wind part 22 out is a part corresponding to the outermost one wind of the negative electrode 22 in the electrode wound body 20. In contrast, in the innermost wind of the electrode wound body 20, the negative electrode 22 is positioned on the inner side relative to the positive electrode 21. In other words, an innermost negative electrode wind part that is positioned in an innermost wind of the negative electrode 22 included in the electrode wound body 20 is positioned on the inner side relative to an innermost positive electrode wind part that is positioned in an innermost wind of the positive electrode 21 included in the electrode wound body 20. Here, the innermost positive electrode wind part is a part corresponding to the innermost one wind of the positive electrode 21 in the electrode wound body 20. The innermost negative electrode wind part is a part corresponding to the innermost one wind of the negative electrode 22 in the electrode wound body 20. The number of winds of each of the positive electrode 21, the negative electrode 22, and the separator 23 is not particularly limited, and may be chosen as desired.

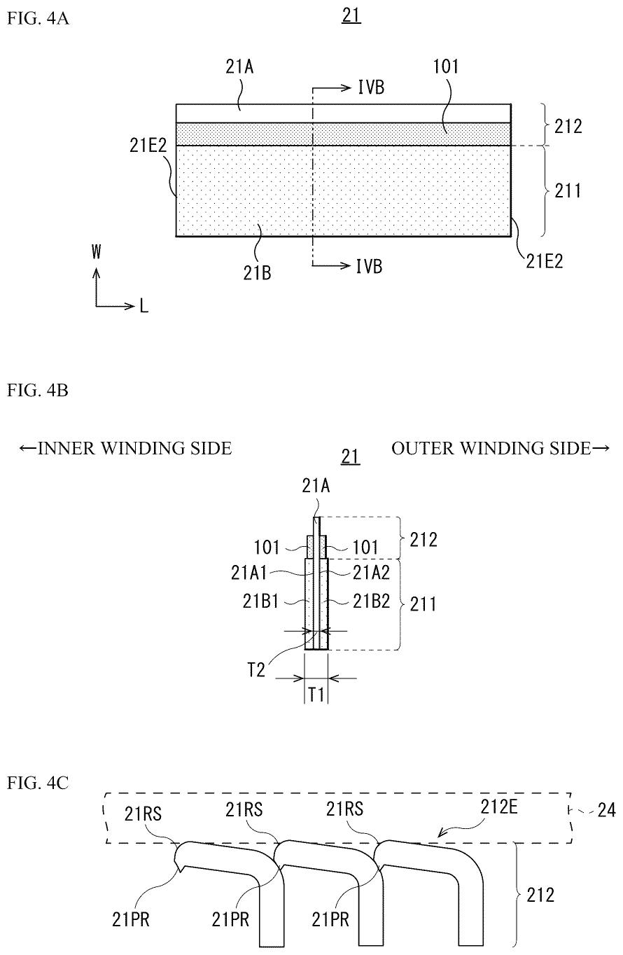

FIG. 4A is a developed view of the positive electrode 21, and schematically illustrates a state before being wound. FIG. 4B illustrates a sectional configuration of the positive electrode 21. Note that FIG. 4B illustrates a section of the positive electrode 21 as viewed in an arrowed direction along line IVB-IVB illustrated in FIG. 4A. The positive electrode 21 includes, for example, a positive electrode current collector 21A, and a positive electrode active material layer 21B provided on the positive electrode current collector 21A. For example, the positive electrode active material layer 21B may be provided only on one of two opposite surfaces of the positive electrode current collector 21A, or may be provided on each of the two opposite surfaces of the positive electrode current collector 21A. FIG. 4B illustrates a case where the positive electrode active material layer 21B is provided on each of the two opposite surfaces of the positive electrode current collector 21A. More specifically, the positive electrode current collector 21A includes an inward positive electrode current collector surface 21A1 facing toward a winding center side of the electrode wound body 20, that is, facing toward the central axis CL, and an outward positive electrode current collector surface 21A2 facing toward a side opposite to the winding center side of the electrode wound body 20, that is, positioned on a side opposite to the inward positive electrode current collector surface 21A1. The positive electrode 21 includes, as the positive electrode active material layers 21B, an inner winding side positive electrode active material layer 21B1 covering all or a part of the inward positive electrode current collector surface 21A1, and an outer winding side positive electrode active material layer 21B2 covering all or a part of the outward positive electrode current collector surface 21A2. Note that in the present specification, the inner winding side positive electrode active material layer 21B1 and the outer winding side positive electrode active material layer 21B2 may each be generically referred to as the positive electrode active material layer 21B, without being distinguished from each other.

The positive electrode 21 includes a positive electrode covered region 211 in which the positive electrode current collector 21A is covered with the positive electrode active material layer 21B, and a positive electrode exposed region 212 in which the positive electrode current collector 21A is exposed without being covered with the positive electrode active material layer 21B. As illustrated in FIG. 4A, the positive electrode covered region 211 and the positive electrode exposed region 212 each extend from an inner winding side edge 21E1 to an outer winding side edge 21E2 along the L-axis direction, i.e., the longitudinal direction of the positive electrode 21, in the electrode wound body 20. Here, the L-axis direction corresponds to a winding direction of the electrode wound body 20. In other words, in the positive electrode 21, the positive electrode current collector 21A is covered with the positive electrode active material layer 21B from the inner winding side edge 21E1 of the positive electrode 21 to the outer winding side edge 21E2 of the positive electrode 21 in the winding direction of the electrode wound body 20. The positive electrode covered region 211 and the positive electrode exposed region 212 are adjacent to each other in the W-axis direction, i.e., the transverse direction of the positive electrode 21. The W-axis direction substantially coincides with the central axis CL. Further, as illustrated in FIG. 2, in the electrode wound body 20, the inner winding side edge 21E1 of the innermost positive electrode wind part is positioned to be inwardly retracted relative to an inner winding side edge 22E1 of the innermost negative electrode wind part.

FIGS. 4A and 4B each schematically illustrate the positive electrode current collector 21A in a state of being straightened along the W-axis direction. In actuality, however, as illustrated in FIG. 1, positive electrode edge parts 212E of the positive electrode exposed region 212 are bent toward the central axis CL and coupled to the positive electrode current collector plate 24. As illustrated in FIG. 4C, the multiple positive electrode edge parts 212E overlap each other and each have an end that includes a curved face 21RS serving as a second curved face. FIG. 4C is an enlarged sectional diagram illustrating an enlarged view of the positive electrode edge parts 212E of the positive electrode 21. The curved face 21RS is a drooped face formed upon, for example, shearing. The curved face 21RS faces the positive electrode current collector plate 24. The end of each of the multiple positive electrode edge parts 212E further includes a projection 21PR serving as a second projection. The projection 21PR projects toward a side opposite to the positive electrode current collector plate 24. The projection 21PR is a burr formed upon, for example, shearing. An insulating layer 101 is preferably provided in a region including a border between the positive electrode covered region 211 and the positive electrode exposed region 212 and the vicinity of the border. As with the positive electrode covered region 211 and the positive electrode exposed region 212, the insulating layer 101 also preferably extends from the inner winding side edge 21E1 to the outer winding side edge 21E2 in the electrode wound body 20. Further, the insulating layer 101 is preferably adhered to the first separator member 23A, the second separator member 23B, or both. One reason for this is that this makes it possible to prevent the positive electrode 21 and the separator 23 from becoming misaligned with each other. Further, the insulating layer 101 preferably includes a resin including polyvinylidene difluoride (PVDF). One reason for this is that when the insulating layer 101 includes PVDF, the insulating layer 101 is swollen by, for example, a solvent included in the electrolytic solution, which allows the insulating layer 101 to be favorably adhered to the separator 23. Note that a detailed configuration of the positive electrode 21 will be described later.

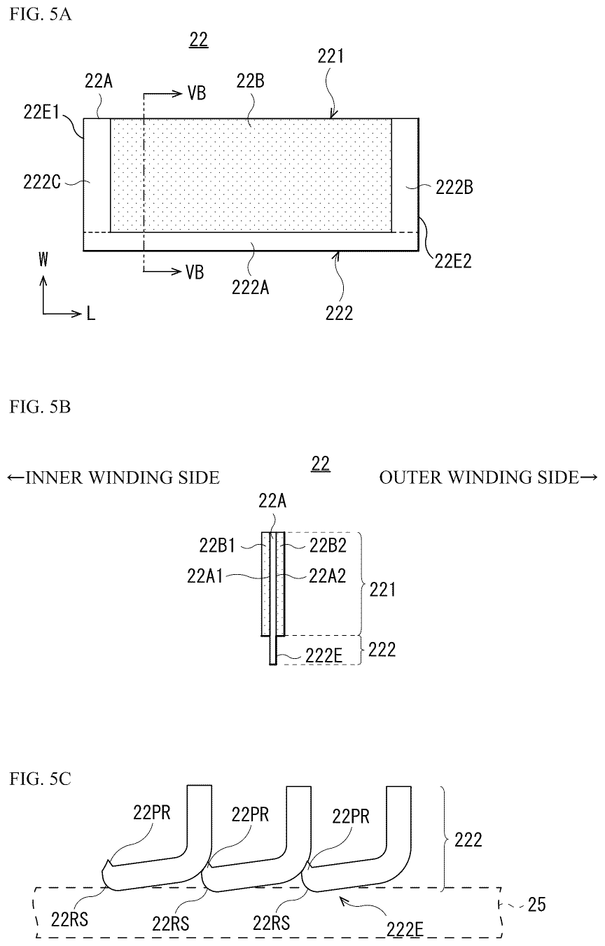

FIG. 5A is a developed view of the negative electrode 22, and schematically illustrates a state before being wound. FIG. 5B illustrates a sectional configuration of the negative electrode 22. Note that FIG. 5B illustrates a section of the negative electrode 22 as viewed in an arrowed direction along line VB-VB illustrated in FIG. 5A. The negative electrode 22 includes, for example, a negative electrode current collector 22A, and a negative electrode active material layer 22B provided on the negative electrode current collector 22A. For example, the negative electrode active material layer 22B may be provided only on one of two opposite surfaces of the negative electrode current collector 22A, or may be provided on each of the two opposite surfaces of the negative electrode current collector 22A. FIG. 5B illustrates a case where the negative electrode active material layer 22B is provided on each of the two opposite surfaces of the negative electrode current collector 22A. More specifically, the negative electrode current collector 22A includes an inward negative electrode current collector surface 22A1 facing toward the winding center side of the electrode wound body 20, that is, facing toward the central axis CL, and an outward negative electrode current collector surface 22A2 facing toward the side opposite to the winding center side of the electrode wound body 20, that is, positioned on a side opposite to the inward negative electrode current collector surface 22A1. The negative electrode 22 includes, as the negative electrode active material layers 22B, an inner winding side negative electrode active material layer 22B1 covering all or a part of the inward negative electrode current collector surface 22A1, and an outer winding side negative electrode active material layer 22B2 covering all or a part of the outward negative electrode current collector surface 22A2. Note that in the present specification, the inner winding side negative electrode active material layer 22B1 and the outer winding side negative electrode active material layer 22B2 may each be generically referred to as the negative electrode active material layer 22B, without being distinguished from each other.

The negative electrode 22 includes a negative electrode covered region 221 in which the negative electrode current collector 22A is covered with the negative electrode active material layer 22B, and a negative electrode exposed region 222 in which the negative electrode current collector 22A is exposed without being covered with the negative electrode active material layer 22B. As illustrated in FIG. 5A, the negative electrode covered region 221 and the negative electrode exposed region 222 each extend along the L-axis direction, i.e., the longitudinal direction of the negative electrode 22. The negative electrode exposed region 222 extends from the inner winding side edge 22E1 of the negative electrode 22 to an outer winding side edge 22E2 of the negative electrode 22 in the winding direction of the electrode wound body 20. In contrast, the negative electrode covered region 221 is provided at neither the inner winding side edge 22E1 of the negative electrode 22 nor the outer winding side edge 22E2 of the negative electrode 22. As illustrated in FIG. 5A, portions of the negative electrode exposed region 222 are so provided as to allow the negative electrode covered region 221 to be interposed therebetween in the L-axis direction, i.e., the longitudinal direction of the negative electrode 22. Specifically, the negative electrode exposed region 222 includes a first part 222A, a second part 222B, and a third part 222C. The first part 222A is provided to be adjacent to the negative electrode covered region 221 in the W-axis direction, and extends from the inner winding side edge 22E1 of the negative electrode 22 to the outer winding side edge 22E2 of the negative electrode 22 in the L-axis direction. The second part 222B and the third part 222C are so provided as to allow the negative electrode covered region 221 to be interposed therebetween in the L-axis direction. The second part 222B is positioned in a region including the outer winding side edge 22E2 of the negative electrode 22 and the vicinity thereof, for example. The third part 222C is positioned in a region including the inner winding side edge 22E1 of the negative electrode 22 and the vicinity thereof. Note that FIGS. 5A and 5B each schematically illustrate the negative electrode current collector 22A in a state of being straightened along the W-axis direction. In actuality, however, as illustrated in FIG. 1, negative electrode edge parts 222E of the negative electrode exposed region 222 are bent toward the central axis CL and coupled to the negative electrode current collector plate 25. A detailed configuration of the negative electrode 22 will be described later.

In the stacked body S20 in the electrode wound body 20, the positive electrode 21 and the negative electrode 22 are so stacked with the separator 23 interposed therebetween that the positive electrode exposed region 212 and the first part 222A of the negative electrode exposed region 222 face toward mutually opposite directions along the W-axis direction, i.e., a width direction. In the electrode wound body 20, an end part of the separator 23 is fixed by attaching a fixing tape 46 to a side surface part 45 of the electrode wound body 20, which prevents loosening of winding.

In the secondary battery 1, as illustrated in FIG. 2, A >B is preferably satisfied, where A is a width of the positive electrode exposed region 212, and B is a width of the first part 222A of the negative electrode exposed region 222. For example, when the width A is 7 (mm), the width B is 4 (mm). Further, C>D is preferably satisfied, where C is a width of a portion of the positive electrode exposed region 212 protruding from an outer edge in the width direction of the separator 23, and D is a width of a portion of the first part 222A of the negative electrode exposed region 222 protruding from an opposite outer edge in the width direction of the separator 23. For example, when the width C is 4.5 (mm), the width D is 3 (mm).

As illustrated in FIG. 1, in the upper part of the secondary battery 1, the multiple positive electrode edge parts 212E, of the positive electrode exposed region 212 wound around the central axis CL, that are adjacent to each other in a radial direction (an R direction) of the electrode wound body 20 are so bent toward the central axis CL as to overlap each other to thereby form an end face 41 of an upper part of the electrode wound body 20. Similarly, in the lower part of the secondary battery 1, the multiple negative electrode edge parts 222E, of the negative electrode exposed region 222 wound around the central axis CL, that are adjacent to each other in the radial direction (the R direction) are so bent toward the central axis CL as to overlap each other to thereby form an end face 42 of a lower part of the electrode wound body 20. Accordingly, the multiple positive electrode edge parts 212E of the positive electrode exposed region 212 gather at the end face 41 of the upper part of the electrode wound body 20, and the multiple negative electrode edge parts 222E of the negative electrode exposed region 222 gather at the end face 42 of the lower part of the electrode wound body 20. To achieve better contact between the positive electrode current collector plate 24 that is provided for extracting a current and the multiple positive electrode edge parts 212E, the multiple positive electrode edge parts 212E are bent toward the central axis CL and form a flat surface. Similarly, to achieve better contact between the negative electrode current collector plate 25 that is provided for extracting a current and the multiple negative electrode edge parts 222E, the multiple negative electrode edge parts 222E are bent toward the central axis CL and form a flat surface. Note that as used herein, the term “flat surface” encompasses not only a completely flat surface but also a surface having some asperities or surface roughness to the extent that joining of the positive electrode exposed region 212 to the positive electrode current collector plate 24 and joining of the negative electrode exposed region 222 to the negative electrode current collector plate 25 are possible.

As illustrated in FIG. 5C, the multiple negative electrode edge parts 222E overlapping each other each have an end that includes a curved face 22RS serving as a first curved face. FIG. 5C is an enlarged sectional diagram illustrating an enlarged view of the negative electrode edge parts 222E of the negative electrode 22. The curved face 22RS is a drooped face formed upon, for example, shearing. The curved face 22RS faces the negative electrode current collector plate 25. The end of each of the multiple negative electrode edge parts 222E further includes a projection 22PR serving as a first projection. The projection 22PR projects toward a side opposite to the negative electrode current collector plate 25. The projection 22PR is a burr formed upon, for example, shearing.

The positive electrode current collector 21A includes, for example, an aluminum foil, as will be described later. In contrast, the negative electrode current collector 22A includes, for example, a copper foil, as will be described later. In this case, the positive electrode current collector 21A is softer than the negative electrode current collector 22A. In other words, the positive electrode exposed region 212 has a Young's modulus lower than a Young's modulus of the negative electrode exposed region 222. Accordingly, in an embodiment, it is more preferable that the widths A to D satisfy a relationship of A>B and C>D. In such a case, when the positive electrode exposed region 212 and the negative electrode exposed region 222 are simultaneously bent with equal pressures from respective electrode sides, the bent portion in the positive electrode 21 and the bent portion in the negative electrode 22 may sometimes have substantially equal heights measured from respective ends of the separator 23. In this case, the multiple positive electrode edge parts 212E (FIG. 1) of the positive electrode exposed region 212 appropriately overlap each other by being bent. This allows for easy joining of the positive electrode exposed region 212 and the positive electrode current collector plate 24 to each other. Similarly, the multiple negative electrode edge parts 222E (FIG. 1) of the negative electrode exposed region 222 appropriately overlap each other by being bent. This allows for easy joining of the negative electrode exposed region 222 and the negative electrode current collector plate 25 to each other. As used herein, the term “joining” refers to coupling by, for example, laser welding; however, a method of joining is not limited to laser welding.

As illustrated in FIG. 2, a portion, of the positive electrode exposed region 212 of the positive electrode 21, that is opposed to the negative electrode 22 with the separator 23 interposed therebetween is covered with the insulating layer 101. The insulating layer 101 has a width of 3 mm in the W-axis direction, for example. The insulating layer 101 entirely covers the portion, of the positive electrode exposed region 212 of the positive electrode 21, that is opposed to the negative electrode covered region 221 of the negative electrode 22 with the separator 23 interposed therebetween. The insulating layer 101 makes it possible to effectively prevent an internal short circuit of the secondary battery 1 when foreign matter enters between the negative electrode covered region 221 and the positive electrode exposed region 212, for example. Further, when the secondary battery 1 undergoes an impact, the insulating layer 101 absorbs the impact and thereby makes it possible to effectively prevent bending of the positive electrode exposed region 212 and a short circuit between the positive electrode exposed region 212 and the negative electrode 22.

The secondary battery 1 may further include insulating tapes 53 and 54 in a gap between the outer package can 11 and the electrode wound body 20. The positive electrode exposed region 212 having the parts gathering at the end face 41 and the negative electrode exposed region 222 having the parts gathering at the end face 42 are electrical conductors, such as metal foils, that are exposed. Accordingly, if the positive electrode exposed region 212 and the negative electrode exposed region 222 are in proximity to the outer package can 11, a short circuit between the positive electrode 21 and the negative electrode 22 can occur via the outer package can 11. A short circuit can also occur when the positive electrode current collector plate 24 on the end face 41 and the outer package can 11 come into proximity to each other. To address this, it is preferable to provide the insulating tapes 53 and 54 as insulating members. Each of the insulating tapes 53 and 54 is an adhesive tape including a base layer, and an adhesive layer provided on one surface of the base layer. The base layer includes, for example, any of polypropylene, polyethylene terephthalate, and polyimide. To prevent the provision of the insulating tapes 53 and 54 from resulting in a decreased capacity of the electrode wound body 20, the insulating tapes 53 and 54 are disposed not to overlap the fixing tape 46 attached to the side surface part 45, and each have a thickness set to be less than or equal to a thickness of the fixing tape 46.

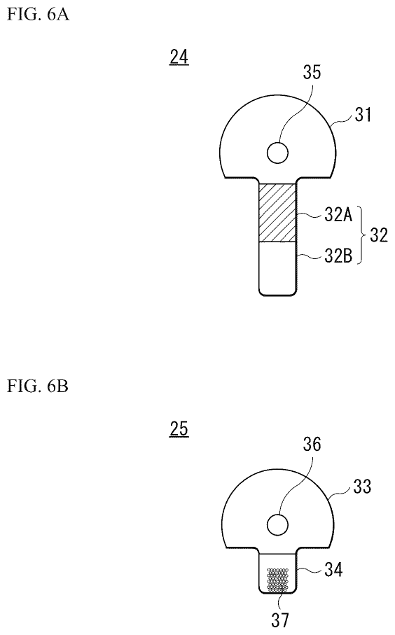

In a typical lithium-ion secondary battery, for example, a lead for current extraction is welded to one location on each of the positive electrode and the negative electrode. However, such a structure increases the internal resistance of the lithium-ion secondary battery and causes the lithium-ion secondary battery to generate heat and become hot upon discharging; therefore, the structure is unsuitable for high-rate discharging. To address this, in the secondary battery 1 according to the present embodiment, the positive electrode current collector plate 24 is disposed to face the end face 41, and the negative electrode current collector plate 25 is disposed to face the end face 42. In addition, the positive electrode edge parts 212E of the positive electrode exposed region 212 present at the end face 41 and the positive electrode current collector plate 24 are joined to each other at multiple points; and the negative electrode edge parts 222E of the negative electrode exposed region 222 present at the end face 42 and the negative electrode current collector plate 25 are joined to each other at multiple points. The joining of the positive electrode edge parts 212E and the positive electrode current collector plate 24 to each other and the joining of the negative electrode edge parts 222E and the negative electrode current collector plate 25 to each other are performed by, for example, laser welding. A reduced internal resistance of the secondary battery 1 is thereby achieved. Each of the end faces 41 and 42 is a flat surface, as described above, which also contributes to the reduced resistance. The positive electrode current collector plate 24 is electrically coupled to the battery cover 14 via the safety valve mechanism 30, for example. The negative electrode current collector plate 25 is electrically coupled to the outer package can 11, for example. FIG. 6A is a schematic diagram illustrating a configuration example of the positive electrode current collector plate 24. FIG. 6B is a schematic diagram illustrating a configuration example of the negative electrode current collector plate 25. The positive electrode current collector plate 24 is a metal plate including, for example, aluminum or an aluminum alloy as a single component, or a composite material of aluminum and the aluminum alloy. The negative electrode current collector plate 25 is a metal plate including, for example, nickel, a nickel alloy, copper, or a copper alloy as a single component, or a composite material of two or more thereof.

As illustrated in FIG. 6A, the positive electrode current collector plate 24 has a shape in which a band-shaped part 32 having a substantially rectangular shape is coupled to a fan-shaped part 31 having a substantially fan shape. The fan-shaped part 31 has a through hole 35 in the vicinity of a middle thereof. In the secondary battery 1, the positive electrode current collector plate 24 is provided to allow the through hole 35 to overlap the through hole 26 in the Z-axis direction. A hatched portion in FIG. 6A represents an insulating part 32A of the band-shaped part 32. The insulating part 32A is a portion of the band-shaped part 32 and has an insulating tape attached thereto or an insulating material applied thereto. Of the band-shaped part 32, a portion below the insulating part 32A is a coupling part 32B to be coupled to a sealing plate that also serves as an external terminal. Note that when the secondary battery 1 has a battery structure without a metallic center pin in the through hole 26 as illustrated in FIG. 1, there is a low possibility that the band-shaped part 32 will come into contact with a region of a negative electrode potential. In such a case, the positive electrode current collector plate 24 does not have to include the insulating part 32A. When the positive electrode current collector plate 24 does not include the insulating part 32A, it is possible to increase a width of each of the positive electrode 21 and the negative electrode 22 by an amount corresponding to a thickness of the insulating part 32A to thereby increase a charge and discharge capacity.

The negative electrode current collector plate 25 illustrated in FIG. 6B has a shape similar to the shape of the positive electrode current collector plate 24 illustrated in FIG. 6A. Note that the negative electrode current collector plate 25 has a band-shaped part 34 different from the band-shaped part 32 of the positive electrode current collector plate 24. The band-shaped part 34 of the negative electrode current collector plate 25 is shorter than the band-shaped part 32 of the positive electrode current collector plate 24, and includes no portion corresponding to the insulating part 32A of the positive electrode current collector plate 24. The band-shaped part 34 is provided with projections 37 that each have a round shape and that are depicted as multiple circles. Upon resistance welding, a current concentrates on the projections 37, which causes the projections 37 to melt to cause the band-shaped part 34 to be welded to a bottom of the outer package can 11. As with the positive electrode current collector plate 24, the negative electrode current collector plate 25 has a through hole 36 in the vicinity of a middle of a fan-shaped part 33. In the secondary battery 1, the negative electrode current collector plate 25 is provided to allow the through hole 36 to overlap the through hole 26 in the Z-axis direction.

The fan-shaped part 31 of the positive electrode current collector plate 24 covers only a portion of the end face 41, owing to a plan shape of the fan-shaped part 31. Similarly, the fan-shaped part 33 of the negative electrode current collector plate 25 covers only a portion of the end face 42, owing to a plan shape of the fan-shaped part 33. Reasons why the fan-shaped part 31 does not entirely cover the end face 41 and why the fan-shaped part 33 does not entirely cover the end face 42 include the following two reasons, for example. A first reason is to allow the electrolytic solution to smoothly permeate the electrode wound body 20 in assembling the secondary battery 1, for example. A second reason is to allow a gas generated when the lithium-ion secondary battery comes into an abnormally hot state or an overcharged state to be easily released to the outside.

The positive electrode current collector 21A includes an electrically conductive material such as aluminum, for example. The positive electrode current collector 21A is a metal foil including aluminum or an aluminum alloy, for example.

The positive electrode active material layer 21B includes, as a positive electrode active material, any one or more of positive electrode materials into which lithium is insertable and from which lithium is extractable. Note that the positive electrode active material layer 21B may further include any one or more of other materials. Examples of the other materials include a positive electrode binder and a positive electrode conductor. It is preferable that the positive electrode material be a lithium-containing compound, and more specifically, a lithium-containing composite oxide or a lithium-containing phosphoric acid compound, for example. The lithium-containing composite oxide is an oxide including lithium and one or more of other elements, that is, one or more of elements other than lithium, as constituent elements. The lithium-containing composite oxide has any of crystal structures including, without limitation, a layered rock-salt crystal structure and a spinel crystal structure, for example. The lithium-containing phosphoric acid compound is a phosphoric acid compound including lithium and one or more of other elements as constituent elements, and has a crystal structure such as an olivine crystal structure, for example. The positive electrode active material layer 21B preferably includes, as the positive electrode active material, at least one of lithium cobalt oxide, lithium nickel cobalt manganese oxide, or lithium nickel cobalt aluminum oxide, in particular. The positive electrode binder includes, for example, any one or more of materials including, without limitation, a synthetic rubber and a polymer compound. Examples of the synthetic rubber include a styrene-butadiene-based rubber, a fluorine-based rubber, and ethylene propylene diene. Examples of the polymer compound include polyvinylidene difluoride and polyimide. The positive electrode conductor includes, for example, any one or more of materials including, without limitation, a carbon material. Examples of the carbon material include graphite, carbon black, acetylene black, and Ketjen black. Note that the positive electrode conductor may be any of electrically conductive materials, and may be, for example, a metal material or an electrically conductive polymer.

The negative electrode current collector 22A includes an electrically conductive material such as copper, for example. The negative electrode current collector 22A is a metal foil including, for example, nickel, a nickel alloy, copper, or a copper alloy. A surface of the negative electrode current collector 22A is preferably roughened. One reason for this is that this improves adherence of the negative electrode active material layer 22B to the negative electrode current collector 22A owing to what is called an anchor effect. In this case, the surface of the negative electrode current collector 22A is to be roughened at least in a region facing the negative electrode active material layer 22B. Examples of a roughening method include a method in which microparticles are formed through an electrolytic treatment. In the electrolytic treatment, the microparticles are formed on the surface of the negative electrode current collector 22A by an electrolytic method in an electrolyzer. This provides the surface of the negative electrode current collector 22A with asperities. A copper foil produced by the electrolytic method is generally called an electrolytic copper foil.

The negative electrode active material layer 22B includes, as a negative electrode active material, any one or more of negative electrode materials into which lithium is insertable and from which lithium is extractable. Note that the negative electrode active material layer 22B may further include any one or more of other materials. Examples of the other materials include a negative electrode binder and a negative electrode conductor. For example, the negative electrode material is a carbon material. One reason for this is that the carbon material exhibits very little change in crystal structure at the time of insertion and extraction of lithium, and a high energy density is thus obtainable stably. Another reason is that the carbon material also serves as a negative electrode conductor, which allows the negative electrode active material layer 22B to be improved in electrically conductive property. Examples of the carbon material include graphitizable carbon, non-graphitizable carbon, and graphite. Note that spacing of a (002) plane of the non-graphitizable carbon is preferably 0.37 nm or greater. Spacing of a (002) plane of the graphite is preferably 0.34 nm or less. More specific examples of the carbon material include pyrolytic carbons, cokes, glassy carbon fibers, an organic polymer compound fired body, activated carbon, and carbon blacks. Examples of the cokes include pitch coke, needle coke, and petroleum coke. The organic polymer compound fired body is a resultant of firing or carbonizing a polymer compound such as a phenol resin or a furan resin at a suitable temperature. Other than the above, the carbon material may be low-crystalline carbon heat-treated at a temperature of about 1000° C. or lower, or may be amorphous carbon. Note that the carbon material may have any of a fibrous shape, a spherical shape, a granular shape, and a flaky shape. In the secondary battery 1, when an open circuit voltage in a fully charged state, that is, a battery voltage is 4.25 V or higher, the amount of extracted lithium per unit mass increases as compared with when the open circuit voltage in the fully charged state is 4.20 V, even with the same positive electrode active material. The amount of the positive electrode active material and the amount of the negative electrode active material are therefore adjusted accordingly. This makes it possible to obtain a high energy density.

The negative electrode active material layer 22B may include, as the negative electrode active material, a silicon-containing material including at least one of silicon, silicon oxide, a carbon-silicon compound, or a silicon alloy. The term “silicon-containing material” is a generic term for a material that includes silicon as a constituent element. Note that the silicon-containing material may include only silicon as the constituent element. One silicon-containing material may be used, or two or more silicon-containing materials may be used. The silicon-containing material is able to form an alloy with lithium, and may be a simple substance of silicon, a silicon alloy, a silicon compound, a mixture of two or more thereof, or a material including one or more phases thereof. Further, the silicon-containing material may be crystalline or amorphous, or may include both a crystalline part and an amorphous part. Note that the simple substance described here refers to a simple substance merely in a general sense. The simple substance may thus include a small amount of impurity. In other words, purity of the simple substance is not limited to 100%. The silicon alloy includes, as one or more constituent elements other than silicon, any one or more of elements including, without limitation, tin, nickel, copper, iron, cobalt, manganese, zinc, indium, silver, titanium, germanium, bismuth, antimony, and chromium, for example. The silicon compound includes, as one or more constituent elements other than silicon, any one or more of elements including, without limitation, carbon and oxygen, for example. Note that the silicon compound may include, as one or more constituent elements other than silicon, any one or more of the series of constituent elements described above in relation to the silicon alloy, for example. Specific examples of the silicon alloy and the silicon compound include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, and SiOᵥ (where 0<v≤2). Note that v may be set within any desired range, and may, for example, fall within the following range: 0.2<v≤1.4.

The separator 23 is interposed between the positive electrode 21 and the negative electrode 22. The separator 23 allows lithium ions to pass through and prevents a short circuit of a current caused by contact between the positive electrode 21 and the negative electrode 22. The separator 23 includes, for example, any one or more kinds of porous films each including, for example, a synthetic resin or a ceramic, and may include a stacked film of two or more kinds of porous films. Examples of the synthetic resin include polytetrafluoroethylene, polypropylene, and polyethylene. Note that the separator 23 preferably includes the bases that each include a single-layer polyolefin porous film including polyethylene. One reason for this is that a favorable high output characteristic is obtainable as compared with a stacked film. When the first separator member 23A and the second separator member included in the separator 23 each include a single-layer porous film including polyolefin, the porous film preferably has a thickness of greater than or equal to 10 μm and less than or equal to 15 μm, for example. An internal short circuit is sufficiently avoidable if the single-layer porous film including polyolefin has a thickness of greater than or equal to 10 μm. A more favorable discharge capacity characteristic is achievable if the thickness of the single-layer porous film including polyolefin is less than or equal to 15 μm. Further, the porous film preferably has a surface density of greater than or equal to 6.3 g/m² and less than or equal to 8.3 g/m², for example. An internal short circuit is sufficiently avoidable if the surface density of the single-layer porous film including polyolefin is greater than or equal to 6.3 g/m². A more favorable discharge capacity characteristic is achievable if the surface density of the single-layer porous film including polyolefin is less than or equal to 8.3 g/m².

In particular, the separator 23 may include, for example, the porous film as each of the above-described bases, and a polymer compound layer provided on one of or each of two opposite surfaces of each of the bases. One reason for this is that adherence of the separator 23 to each of the positive electrode 21 and the negative electrode 22 improves, which suppresses distortion of the electrode wound body 20. As a result, a decomposition reaction of the electrolytic solution is suppressed, and leakage of the electrolytic solution with which the bases are impregnated is also suppressed. This prevents an easy increase in resistance even upon repeated charging and discharging, and also suppresses swelling of the battery. The polymer compound layer includes a polymer compound such as polyvinylidene difluoride, for example. One reason for this is that the polymer compound such as polyvinylidene difluoride has superior physical strength and is electrochemically stable. Note that the polymer compound may be other than polyvinylidene difluoride. To form the polymer compound layer, for example, a solution in which the polymer compound is dissolved in a solvent such as an organic solvent is applied on the base, following which the base is dried. Alternatively, the base may be immersed in the solution and thereafter dried. The polymer compound layer may include any one or more kinds of insulating particles such as inorganic particles, for example. Examples of the kind of the inorganic particles include aluminum oxide and aluminum nitride.

The electrolytic solution includes a solvent and an electrolyte salt. Note that the electrolytic solution may further include any one or more of other materials. Examples of the other materials include an additive. The solvent includes any one or more of nonaqueous solvents including, without limitation, an organic solvent. An electrolytic solution including a nonaqueous solvent is what is called a nonaqueous electrolytic solution. The nonaqueous solvent includes a fluorine compound and a dinitrile compound, for example. The fluorine compound includes, for example, at least one of fluorinated ethylene carbonate, trifluorocarbonate, trifluoroethyl methyl carbonate, a fluorinated carboxylic acid ester, or a fluorine ether. The nonaqueous solvent may further include at least one of nitrile compounds other than the dinitrile compound. Examples of the nitrile compounds other than the dinitrile compound include a mononitrile compound and a trinitrile compound. For example, succinonitrile (SN) is preferable as the dinitrile compound. Note that the dinitrile compound is not limited to succinonitrile, and may be another dinitrile compound such as adiponitrile.

The electrolyte salt includes, for example, any one or more of salts including, without limitation, a lithium salt. Note that the electrolyte salt may include a salt other than the lithium salt, for example. Examples of the salt other than the lithium salt include a salt of a light metal other than lithium. Examples of the lithium salt include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethanesulfonate (LiCF₃SO₃), lithium tetrachloroaluminate (LiAlCl₄), dilithium hexafluorosilicate (Li₂SiF₆), lithium chloride (LiCl), and lithium bromide (LiBr). In particular, the lithium salt is preferably any one or more of lithium hexafluorophosphate, lithium tetrafluoroborate, lithium perchlorate, or lithium hexafluoroarsenate, and more preferably, lithium hexafluorophosphate. Although not particularly limited, a content of the electrolyte salt is preferably within a range from 0.3 mol/kg to 3 mol/kg both inclusive with respect to the solvent, in particular. When the electrolytic solution includes LiPF₆ as the electrolyte salt, a concentration of LiPF₆ in the electrolytic solution is preferably higher than or equal to 1.25 mol/kg and lower than or equal to 1.45 mol/kg. One reason for this is that this makes it possible to prevent cycle deterioration caused by consumption, or decomposition, of the salt at the time of high load rate charging, and thus allows for improvement in high-load cyclability characteristic. When the electrolytic solution further includes LiBF₄ in addition to LiPF₆ as the electrolyte salt, a concentration of LiBF₄ in the electrolytic solution is preferably higher than or equal to 0.001 (wt %) and lower than or equal to 0.1 (wt %). One reason for this is that this makes it possible to more effectively prevent the cycle deterioration caused by consumption, or decomposition, of the salt at the time of high load rate charging, and thus allows for further improvement in high-load cyclability characteristic.

In the secondary battery 1 according to the present embodiment, for example, upon charging, lithium ions are extracted from the positive electrode 21, and the extracted lithium ions are inserted into the negative electrode 22 via the electrolytic solution. In the secondary battery 1, for example, upon discharging, lithium ions are extracted from the negative electrode 22, and the extracted lithium ions are inserted into the positive electrode 21 via the electrolytic solution.

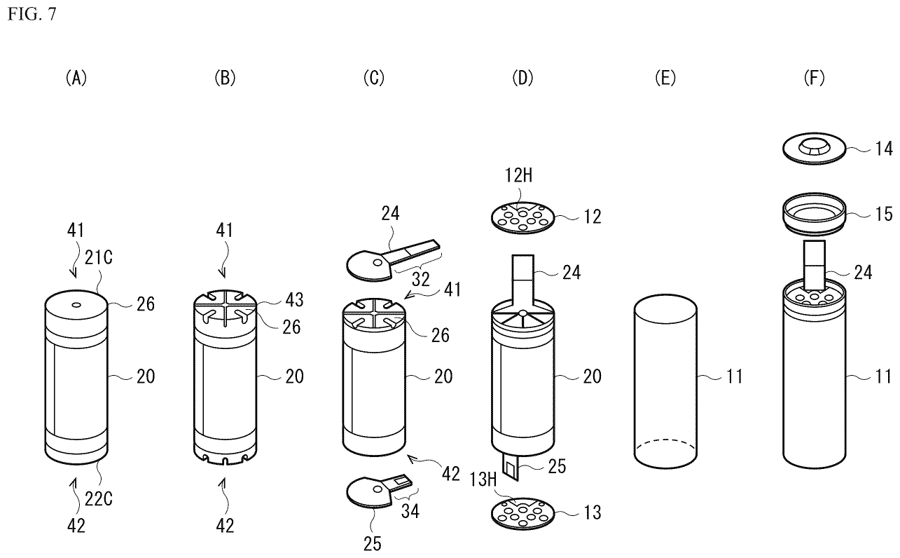

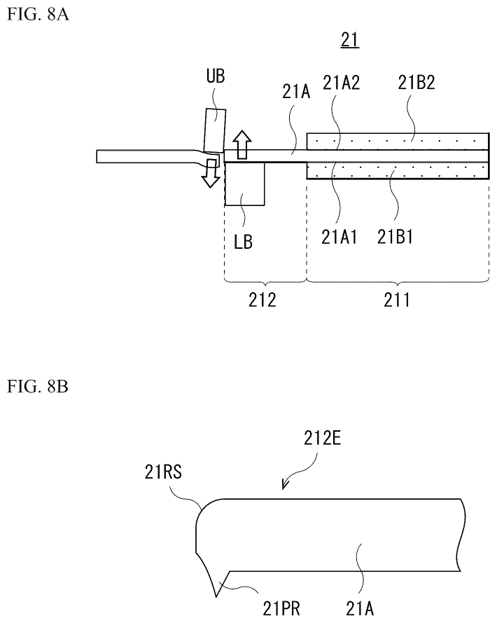

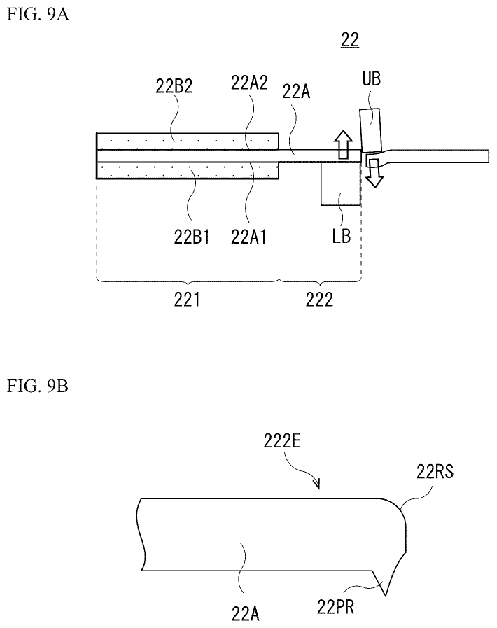

A method of manufacturing the secondary battery 1 will be described with reference to FIGS. 7 to 9B as well as FIGS. 1 to 5B. FIG. 7 is a perspective diagram describing a process of manufacturing the secondary battery illustrated in FIG. 1. FIGS. 8A and 8B are schematic diagrams describing a step of cutting the positive electrode current collector 21A into a predetermined width dimension by shearing. FIGS. 9A and 9B are schematic diagrams describing a step of cutting the negative electrode current collector 22A into a predetermined width dimension by shearing.

First, the positive electrode current collector 21A is prepared, and the positive electrode active material layer 21B is selectively formed on the surface of the positive electrode current collector 21A to thereby form the positive electrode 21 including the positive electrode covered region 211 and the positive electrode exposed region 212. Thereafter, the positive electrode current collector 21A in the positive electrode exposed region 212 is cut to cause the width A (see FIG. 2) of the positive electrode exposed region 212 to be of a predetermined dimension. Specifically, as illustrated in FIG. 8A, for example, with a lower blade LB pressed against the inward positive electrode current collector surface 21A1 and with an upper blade UB pressed against the outward positive electrode current collector surface 21A2, pressures are applied by the lower blade LB and the upper blade UB in respective directions indicated by arrows to thereby shear the positive electrode current collector 21A. As a result, a cut surface is formed that extends in the L-axis direction. The cut surface is a part to be the multiple positive electrode edge parts 212E in the electrode wound body 20. As illustrated in FIG. 8B, the positive electrode edge part 212E includes the curved face 21RS that is a drooped face, and the projection 21PR that is a burr.

Thereafter, the negative electrode current collector 22A is prepared, and the negative electrode active material layer 22B is selectively formed on the surface of the negative electrode current collector 22A to thereby form the negative electrode 22 including the negative electrode covered region 221 and the negative electrode exposed region 222. Thereafter, the negative electrode current collector 22A in the negative electrode exposed region 222 is cut to cause the width B (see FIG. 2) of the first part 222A of the negative electrode exposed region 222 to be of a predetermined dimension. Specifically, as illustrated in FIG. 9A, for example, with the lower blade LB pressed against the inward negative electrode current collector surface 22A1 and with the upper blade UB pressed against the outward negative electrode current collector surface 22A2, pressures are applied by the lower blade LB and the upper blade UB in respective directions indicated by arrows to thereby shear the negative electrode current collector 22A. As a result, a cut surface is formed that extends in the L-axis direction. The cut surface is a part to be the multiple negative electrode edge parts 222E in the electrode wound body 20. As illustrated in FIG. 9B, the negative electrode edge part 222E includes the curved face 22RS that is a drooped face, and the projection 22PR that is a burr.

The positive electrode 21 and the negative electrode 22 fabricated in the above-described manner may be subjected to a drying process. Thereafter, the positive electrode 21 and the negative electrode 22 are stacked, with the first separator member 23A and the second separator member 23B on the positive electrode 21 and the negative electrode 22, respectively, to cause the positive electrode exposed region 212 and the first part 222A of the negative electrode exposed region 222 to be on opposite sides to each other in the W-axis direction. The stacked body S20 is thereby fabricated. Thereafter, the stacked body S20 is so wound in a spiral shape as to form the through hole 26. In addition, the fixing tape 46 is attached to an outermost wind of the stacked body S20 wound in the spiral shape. The electrode wound body 20 is thus obtained as illustrated in part (A) of FIG. 7.

Thereafter, as illustrated in part (B) of FIG. 7, the end faces 41 and 42 of the electrode wound body 20 are each locally bent by pressing an end of, for example, a 0.5-millimeter-thick flat plate against each of the end faces 41 and 42 perpendicularly, that is, in the Z-axis direction. As a result, grooves 43 are formed to extend radiately in radial directions (the R directions) from the through hole 26. Note that the number and arrangement of the grooves 43 illustrated in part (B) of FIG. 7 are merely an example, and the present disclosure is not limited thereto.

Thereafter, as illustrated in part (C) of FIG. 7, substantially equal pressures are applied to the end face 41 and 42 in substantially perpendicular directions from above and below the electrode wound body 20 at substantially the same time. At this time, for example, a rod-shaped jig is placed in the through hole 26 in advance. By this operation, the positive electrode edge parts 212E of the positive electrode exposed region 212 and the negative electrode edge parts 222E of the negative electrode exposed region 222 are bent to thereby make each of the end faces 41 and 42 into a flat surface. At this time, the positive electrode edge parts 212E of the positive electrode exposed region 212 positioned at the end face 41 are caused to bend toward the through hole 26 while overlapping each other, and the negative electrode edge parts 222E of the negative electrode exposed region 222 positioned at the end face 42 are caused to bend toward the through hole 26 while overlapping each other. Thereafter, the fan-shaped part 31 of the positive electrode current collector plate 24 is joined to the end face 41 by a method such as laser welding, and the fan-shaped part 33 of the negative electrode current collector plate 25 is joined to the end face 42 by a method such as laser welding

Thereafter, the insulating tapes 53 and 54 are attached to predetermined locations on the electrode wound body 20. Thereafter, as illustrated in part (D) of FIG. 7, the band-shaped part 32 of the positive electrode current collector plate 24 is bent and inserted through a hole 12H of the insulating plate 12. Further, the band-shaped part 34 of the negative electrode current collector plate 25 is bent and inserted through a hole 13H of the insulating plate 13.

Thereafter, the electrode wound body 20 having been assembled in the above-described manner is placed into the outer package can 11 illustrated in part (E) of FIG. 7, following which a bottom part of the outer package can 11 and the negative electrode current collector plate 25 are welded to each other. Thereafter, a narrow part is formed in the vicinity of the open end part 11N of the outer package can 11. Further, the electrolytic solution is injected into the outer package can 11, following which the band-shaped part 32 of the positive electrode current collector plate 24 and the safety valve mechanism 30 are welded to each other.

Thereafter, as illustrated in part (F) of FIG. 7, sealing is performed with the gasket 15, the safety valve mechanism 30, and the battery cover 14, through the use of the narrow part.

The secondary battery 1 according to the present embodiment is completed in the above-described manner.

As described above, in the secondary battery 1 according to the present embodiment, the multiple positive electrode edge parts 212E of the positive electrode exposed region 212 that are adjacent to each other in the radial direction of the electrode wound body 20 are so bent toward the central axis CL as to overlap each other to thereby form the end face 41. Further, in the secondary battery 1 according to the present embodiment, the multiple negative electrode edge parts 222E of the negative electrode exposed region 222 that are adjacent to each other in the radial direction of the electrode wound body 20 are so bent toward the central axis CL as to overlap each other to thereby form the end face 42. Here, the multiple positive electrode edge parts 212E each include the curved face 21RS, and the multiple negative electrode edge parts 222E each include the curved face 22RS. Accordingly, a contact area between the multiple positive electrode edge parts 212E of the positive electrode current collector 21A and the positive electrode current collector plate 24 increases without causing deformation of the electrode wound body 20, which increases closeness of contact between the multiple positive electrode edge parts 212E and the positive electrode current collector plate 24, and thus allows for a favorable joined state. Similarly, a contact area between the multiple negative electrode edge parts 222E of the negative electrode current collector 22A and the negative electrode current collector plate 25 increases without causing deformation of the electrode wound body 20, which increases closeness of contact between the multiple negative electrode edge parts 222E and the negative electrode current collector plate 25, and thus allows for a favorable joined state. This makes it possible to reduce the internal resistance of the secondary battery 1, and accordingly makes it possible to achieve higher output.

In contrast, for example, if the multiple positive electrode edge parts 212E each include no curved face 21RS and instead include a sharp corner or projection facing the positive electrode current collector plate 24, the positive electrode edge parts 212E and the positive electrode current collector plate would be in point contact with each other; or if the multiple negative electrode edge parts 222E each include no curved face 22RS and instead include a sharp corner or projection facing the negative electrode current collector plate 25, the negative electrode edge parts 222E and the negative electrode current collector plate 25 would be in point contact with each other. In such a case, the contact area between the positive electrode edge parts 212E and the positive electrode current collector plate 24 and the contact area between the negative electrode edge parts 222E and the negative electrode current collector plate 25 each become relatively small as compared with that in the present embodiment.

In the present embodiment, the curved faces 21RS are caused to face the positive electrode current collector plate 24, and the curved faces 22RS are caused to face the negative electrode current collector plate 25. This allows for an increase in contact area between the positive electrode edge parts 212E and the positive electrode current collector plate 24 and an increase in contact area between the negative electrode edge parts 222E and the negative electrode current collector plate 25, and accordingly makes it possible to achieve favorable joined states, as compared with a case without the curved faces 21RS and 22RS. As a result, a reduction in contact resistance at an interface between the positive electrode edge parts 212E and the positive electrode current collector plate 24 and a reduction in contact resistance at an interface between the negative electrode edge parts 222E and the negative electrode current collector plate 25 are achievable.

Further, in the present embodiment, when fabricating the electrode wound body 20, the stacked body is so wound as to allow the projections 21PR to point toward the side opposite to the positive electrode current collector plate 24 and as to allow the projections 22PR to point toward the side opposite to the negative electrode current collector plate 25, in other words, the stacked body is wound with the projections 21PR and 22PR pointing toward the central axis CL, following which the positive electrode edge parts 212E and the negative electrode edge parts 222E are bent. This helps to prevent the positive electrode edge parts 212E and the negative electrode edge parts 222E from easily suffering any unintended creasing or bending, and accordingly makes it possible to easily achieve flatness of the end faces 41 and 42.

If the electrode wound body 20 is so fabricated as to allow the projections 21PR and 22PR to point toward an outer side of the electrode wound body 20, unintended creasing or bending will easily occur on the positive electrode edge parts 212E and the negative electrode edge parts 222E when they are bent. This makes it difficult to achieve a large contact area between the positive electrode edge parts 212E and the positive electrode current collector plate 24 and a large contact area between the negative electrode edge parts 222E and the negative electrode current collector plate 25. In addition, when laser welding is performed to weld the positive electrode edge parts 212E and the positive electrode current collector plate 24 to each other and to weld the negative electrode edge parts 222E and the negative electrode current collector plate 25 to each other, perforation can occur in the positive electrode current collector plate 24 and the negative electrode current collector plate 25, resulting in reduced contact areas. It is therefore desirable to allow the projections 21PR to point toward the side opposite to the positive electrode current collector plate 24 and to allow the projections 22PR to point toward the side opposite to the negative electrode current collector plate 25.

Examples of applications of the secondary battery 1 according to an embodiment of the present disclosure are as described below.

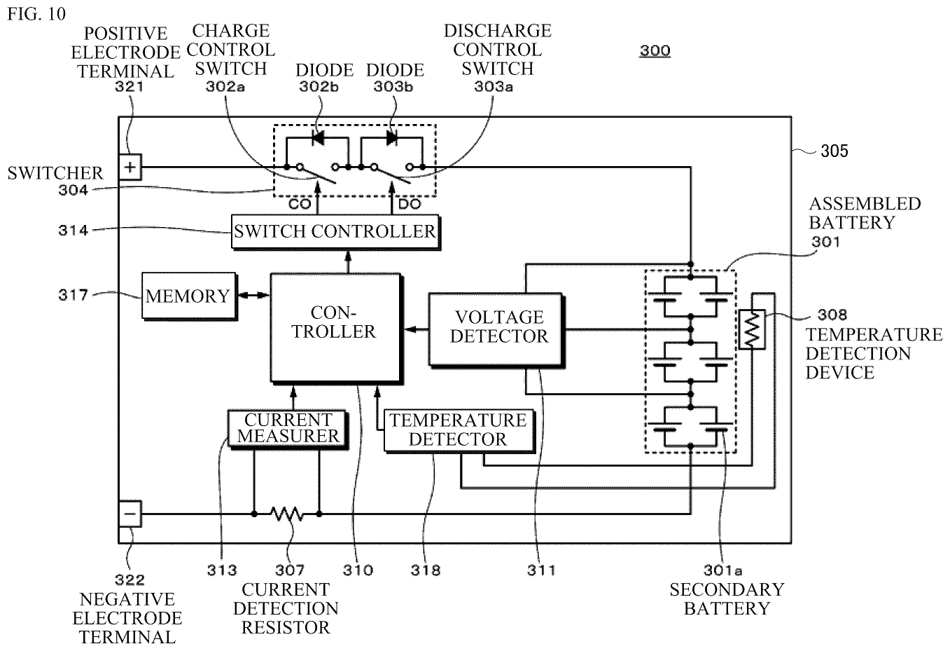

FIG. 10 is a block diagram illustrating a circuit configuration example in which a battery according to an embodiment of the present disclosure, which will hereinafter be referred to as a secondary battery as appropriate, is applied to a battery pack 300. The battery pack 300 includes an assembled battery 301, an outer package body 305, a switcher 304, a current detection resistor 307, a temperature detection device 308, and a controller 310. The outer package body 305 contains the assembled battery 301. The switcher 304 includes a charge control switch 302a and a discharge control switch 303a.

The battery pack 300 includes a positive electrode terminal 321 and a negative electrode terminal 322. Upon charging, the positive electrode terminal 321 and the negative electrode terminal 322 are respectively coupled to a positive electrode terminal and a negative electrode terminal of a charger to thereby perform charging. Upon use of electronic equipment, the positive electrode terminal 321 and the negative electrode terminal 322 are respectively coupled to a positive electrode terminal and a negative electrode terminal of the electronic equipment to thereby perform discharging.

The assembled battery 301 includes multiple secondary batteries 301a coupled in series or in parallel. The secondary battery 1 described above is applicable to each of the secondary batteries 301a. Note that FIG. 10 illustrates an example case in which six secondary batteries 301a are coupled in a two parallel coupling and three series coupling (2P3S) configuration; however, the secondary batteries 301a may be coupled in any other manner such as in any n parallel coupling and m series coupling configuration (where n and m are each an integer).

The switcher 304 includes the charge control switch 302a, a diode 302b, the discharge control switch 303a, and a diode 303b, and is controlled by the controller 310. The diode 302b has a polarity that is in a reverse direction with respect to a charge current flowing in a direction from the positive electrode terminal 321 to the assembled battery 301 and that is in a forward direction with respect to a discharge current flowing in a direction from the negative electrode terminal 322 to the assembled battery 301. The diode 303b has a polarity that is in the forward direction with respect to the charge current and in the reverse direction with respect to the discharge current. Note that although the switcher 304 is provided on a positive side in FIG. 10, the switcher 304 may be provided on a negative side.

The charge control switch 302a is so controlled by a charge and discharge controller that when the battery voltage reaches an overcharge detection voltage, the charge control switch 302a is turned off to thereby prevent the charge current from flowing through a current path of the assembled battery 301. After the charge control switch 302a is turned off, only discharging is enabled through the diode 302b. Further, the charge control switch 302a is so controlled by the controller 310 that when a large current flows upon charging, the charge control switch 302a is turned off to thereby block the charge current flowing through the current path of the assembled battery 301. The discharge control switch 303a is so controlled by the controller 310 that when the battery voltage reaches an overdischarge detection voltage, the discharge control switch 303a is turned off to thereby prevent the discharge current from flowing through the current path of the assembled battery 301. After the discharge control switch 303a is turned off, only charging is enabled through the diode 303b. Further, the discharge control switch 303a is so controlled by the controller 310 that when a large current flows upon discharging, the discharge control switch 303a is turned off to thereby block the discharge current flowing through the current path of the assembled battery 301.

The temperature detection device 308 is, for example, a thermistor. The temperature detection device 308 is provided in the vicinity of the assembled battery 301, measures a temperature of the assembled battery 301, and supplies the measured temperature to the controller 310. A voltage detector 311 measures a voltage of the assembled battery 301 and a voltage of each of the secondary batteries 301a included in the assembled battery 301, performs A/D conversion on the measured voltages, and supplies the converted voltages to the controller 310. A current measurer 313 measures a current by means of the current detection resistor 307, and supplies the measured current to the controller 310. A switch controller 314 controls the charge control switch 302a and the discharge control switch 303a of the switcher 304, based on the voltages inputted from the voltage detector 311 and the current inputted from the current measurer 313.

When a voltage of any of the multiple secondary batteries 301a reaches the overcharge detection voltage or below, or reaches the overdischarge detection voltage or below, or when a large current flows suddenly, the switch controller 314 transmits a control signal to the switcher 304 to thereby prevent overcharging and overdischarging, and overcurrent charging and discharging. For example, when the secondary battery is a lithium-ion secondary battery, the overcharge detection voltage is determined to be, for example, 4.20 V±0.05 V, and the overdischarge detection voltage is determined to be, for example, 2.4 V±0.1 V.

As the charge and discharge control switches, for example, semiconductor switches such as MOSFETs are usable. In this case, parasitic diodes of the MOSFETs serve as the diodes 302b and 303b. When P-channel FETs are used as the charge and discharge control switches, the switch controller 314 supplies control signals CO and DO to a gate of the charge control switch 302a and a gate of the discharge control switch 303a, respectively. When the charge control switch 302a and the discharge control switch 303a are of P-channel type, the charge control switch 302a and the discharge control switch 303a are turned on by a gate potential that is lower than a source potential by a predetermined value or more. That is, in normal charging and discharging operations, the control signals CO and DO are set to a low level to turn on the charge control switch 302a and the discharge control switch 303a.

For example, upon overcharging or overdischarging, the control signals CO and DO are set to a high level to turn off the charge control switch 302a and the discharge control switch 303a.

A memory 317 includes a RAM and a ROM. For example, the memory 317 includes an erasable programmable read only memory (EPROM) as a nonvolatile memory. In the memory 317, values including, without limitation, numerical values calculated by the controller 310 and a battery's internal resistance value of each of the secondary batteries 301a in an initial state measured in the manufacturing process stage, are stored in advance and are rewritable on an as-needed basis. Further, by storing a full charge capacity of the secondary battery 301a, it is possible to calculate, for example, a remaining capacity with the controller 310.

A temperature detector 318 measures a temperature with use of the temperature detection device 308, performs charge and discharge control upon abnormal heat generation, and performs correction in calculating the remaining capacity.

The secondary battery according to an embodiment of the present disclosure is mountable on, or usable to supply electric power to, for example, any of equipment including, without limitation, electronic equipment, an electric vehicle, an electric aircraft, and an electric power storage apparatus.

Examples of the electronic equipment include laptop personal computers, smartphones, tablet terminals, PDAs (i.e., mobile information terminals), mobile phones, wearable terminals, cordless phone handsets, hand-held video recording and playback devices, digital still cameras, electronic books, electronic dictionaries, music players, radios, headphones, game machines, navigation systems, memory cards, pacemakers, hearing aids, electric tools, electric shavers, refrigerators, air conditioners, televisions, stereos, water heaters, microwave ovens, dishwashers, washing machines, dryers, lighting equipment, toys, medical equipment, robots, road conditioners, and traffic lights.

Examples of the electric vehicle include railway vehicles, golf carts, electric carts, and electric automobiles including hybrid electric automobiles. The secondary battery is usable as a driving power source or an auxiliary power source for any of these electric vehicles. Examples of the electric power storage apparatuses include an electric power storage power source for architectural structures including residential houses, or for power generation facilities.

### EXAMPLES

Examples of the present disclosure will be described according to an embodiment.

### Example 1

As described below, the secondary battery 1 of the cylindrical type illustrated in, for example, FIG. 1 was fabricated, following which a battery characteristic of the secondary battery 1 was evaluated. Here, the fabricated secondary battery 1 was a lithium-ion secondary battery with dimensions of 21 mm in diameter and 70 mm in length.

### Fabrication Method

First, an aluminum foil having a thickness of 12 μm was prepared as the positive electrode current collector 21A. Thereafter, a positive electrode mixture was obtained by mixing a layered lithium oxide as the positive electrode active material with a positive electrode binder and a conductive additive. The layered lithium oxide included lithium nickel cobalt aluminum oxide (NCA) having a Ni ratio of 85% or greater. The positive electrode binder included polyvinylidene difluoride. The conductive additive included a mixture of carbon black, acetylene black, and Ketjen black. A mixture ratio between the positive electrode active material, the positive electrode binder, and the conductive additive was set to 96.4:2:1.6. Thereafter, the positive electrode mixture was put into an organic solvent (N-methyl-2-pyrrolidone), following which the organic solvent was stirred to thereby prepare a positive electrode mixture slurry in paste form. Thereafter, the positive electrode mixture slurry was applied on respective predetermined regions of the two opposite surfaces of the positive electrode current collector 21A by means of a coating apparatus, following which the applied positive electrode mixture slurry was dried to thereby form the positive electrode active material layers 21B. Further, a coating material including polyvinylidene difluoride (PVDF) was applied on surfaces of the positive electrode exposed region 212, at respective locations adjacent to the positive electrode covered region 211. The applied coating material was dried to thereby form the insulating layers 101 each having a width of 3 mm and a thickness of 8 μm. Thereafter, the positive electrode active material layers 21B were compression-molded by means of a roll pressing machine. The positive electrode 21 including the positive electrode covered region 211 and the positive electrode exposed region 212 was thus obtained. Thereafter, the positive electrode 21 was sheared to make the positive electrode covered region 211 have a width of 60 mm in the W-axis direction, and to make the positive electrode exposed region 212 have a width of 7 mm in the W-axis direction. A section of the positive electrode edge part 212E of the positive electrode exposed region 212 after the shearing was observed with a microscope VHX-6000 available from Keyence Corporation, at a magnification within a range from about 500 times to about 2000 times to confirm formation of the curved face 21RS and the projection 21PR. A length of the positive electrode 21 in the L-axis direction was set to 1700 mm.

Further, a copper foil having a thickness of 8 μm was prepared as the negative electrode current collector 22A. Thereafter, a negative electrode mixture was obtained by mixing the negative electrode active material with a negative electrode binder and a conductive additive. The negative electrode active material included a mixture of a carbon material and SiO. The carbon material included graphite. The negative electrode binder included polyvinylidene difluoride. The conductive additive included a mixture of carbon black, acetylene black, and Ketjen black. A mixture ratio between the negative electrode active material, the negative electrode binder, and the conductive additive was set to 96.1:2.9:1.0. Further, a mixture ratio between graphite and SiO in the negative electrode active material was set to 95:5. Thereafter, the negative electrode mixture was put into an organic solvent (N-methyl-2-pyrrolidone), following which the organic solvent was stirred to thereby prepare a negative electrode mixture slurry in paste form. Thereafter, the negative electrode mixture slurry was applied on respective predetermined regions of the two opposite surfaces of the negative electrode current collector 22A by means of a coating apparatus, following which the applied negative electrode mixture slurry was dried to thereby form the negative electrode active material layers 22B. Thereafter, the negative electrode active material layers 22B were compression-molded by means of a roll pressing machine. The negative electrode 22 including the negative electrode covered region 221 and the negative electrode exposed region 222 was thus obtained. Thereafter, the negative electrode 22 was sheared to make the negative electrode covered region 221 have a width of 62 mm in the W-axis direction, and to make the first part 222A of the negative electrode exposed region 222 have a width of 4 mm in the W-axis direction. A section of the negative electrode edge part 222E of the negative electrode exposed region 222 after the shearing was observed with the microscope VHX-6000 available from Keyence Corporation, at a magnification within the range from about 500 times to about 2000 times to confirm formation of the curved face 22RS and the projection 22PR. A length of the negative electrode 22 in the L-axis direction was set to 1760 mm.

Thereafter, the positive electrode 21 and the negative electrode 22 were stacked, with the first separator member 23A and the second separator member 23B on the positive electrode 21 and the negative electrode 22, respectively, to cause the positive electrode exposed region 212 and the first part 222A of the negative electrode exposed region 222 to be on opposite sides to each other in the W-axis direction. The stacked body S20 was thereby fabricated. At this time, the stacked body S20 was fabricated not to allow the positive electrode active material layers 21B to protrude from the negative electrode active material layers 22B in the W-axis direction. As each of the first separator member 23A and the second separator member 23B, used was a polyethylene sheet having a width of 65 mm and a thickness of 14 μm. Thereafter, the stacked body S20 was so wound in a spiral shape as to form the through hole 26, and the fixing tape 46 was attached to the outermost wind of the stacked body S20 thus wound. The electrode wound body 20 was thereby obtained.

Thereafter, the end faces 41 and 42 of the electrode wound body 20 were each locally bent by pressing an end of a 0.5-millimeter-thick flat plate against each of the end faces 41 and 42 in the Z-axis direction. The grooves 43 extending radiately in the radial directions (the R directions) from the through hole 26 were thereby formed.

Thereafter, substantially equal pressures were applied to the end faces 41 and 42 in substantially perpendicular directions from above and below the electrode wound body 20 at substantially the same time. The positive electrode exposed region 212 and the first part 222A of the negative electrode exposed region 222 were thereby bent to make each of the end faces 41 and 42 into a flat surface. At this time, the positive electrode edge parts 212E of the positive electrode exposed region 212 positioned at the end face 41 were caused to bend toward the through hole 26 while overlapping each other, and the negative electrode edge parts 222E of the negative electrode exposed region 222 positioned at the end face 42 were caused to bend toward the through hole 26 while overlapping each other. Thereafter, the fan-shaped part 31 of the positive electrode current collector plate 24 was joined to the end face 41 by laser welding, and the fan-shaped part 33 of the negative electrode current collector plate 25 was joined to the end face 42 by laser welding.

Thereafter, the insulating tapes 53 and 54 were attached to the predetermined locations on the electrode wound body 20, following which the band-shaped part 32 of the positive electrode current collector plate 24 was bent and inserted through the hole 12H of the insulating plate 12, and the band-shaped part 34 of the negative electrode current collector plate 25 was bent and inserted through the hole 13H of the insulating plate 13.

Thereafter, the electrode wound body 20 having been assembled in the above-described manner was placed into the outer package can 11, following which the bottom part of the outer package can 11 and the negative electrode current collector plate 25 were welded to each other. Thereafter, a narrow part was formed in the vicinity of the open end part 11N of the outer package can 11. Further, the electrolytic solution was injected into the outer package can 11, following which the band-shaped part 32 of the positive electrode current collector plate 24 and the safety valve mechanism 30 were welded to each other.

As the electrolytic solution, used was a solution including a solvent prepared by adding fluoroethylene carbonate (FEC) and succinonitrile (SN) to a major solvent, i.e., ethylene carbonate (EC) and dimethyl carbonate (DMC), and including LiBF₄ and LiPF₆ as the electrolyte salt. In the lithium-ion secondary battery of the present example, a content ratio (wt %) between EC, DMC, FEC, SN, LiBF₄, and LiPF₆ in the electrolytic solution was set to 12.7:56.2:12.0:1.0:1.0:17.1.

Lastly, sealing was performed with the gasket 15, the safety valve mechanism 30, and the battery cover 14, through the use of the narrow part.

The secondary battery of Example 1 was thus obtained.

### Comparative Example 1

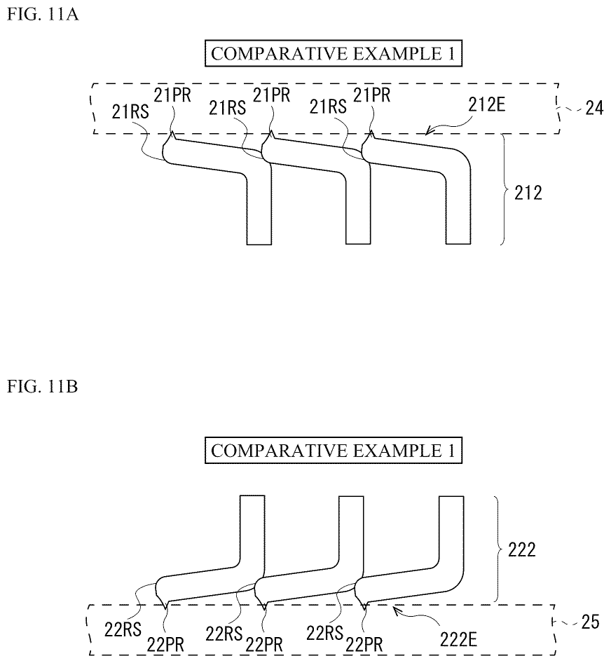

A secondary battery of Comparative Example 1 was fabricated in a similar manner to Example 1 except that the projections 21PR were caused to face the positive electrode current collector plate 24 as illustrated in FIG. 11A and the projections 22PR were caused to face the negative electrode current collector plate 25 as illustrated in FIG. 11B.

### Evaluation of Battery Characteristic

As the battery characteristic of each of the secondary battery of Example 1 and the secondary battery of Comparative Example 1 obtained in the above-described manner, a direct-current resistance value was measured. The results obtained were as presented in Table 1. Specifically, the direct-current resistance value was obtained by calculating a gradient of a voltage when a discharge current was increased from 0 [A] to 100 [A] over five seconds. Note that in Table 1, the direct-current resistance value of the secondary battery of Example 1 is expressed as a relative value, with the direct-current resistance value of the secondary battery of Comparative Example 1 assumed to be 1.

[Table 1]

TABLE 1

| | Direct-current |
|---|---|
| | resistance value [−] |
| Example 1 | 0.93 |
| Comparative | 1 |
| example 1 | |

As indicated in Table 1, Example 1 achieved an about 7% reduction in direct-current resistance value with respect to the direct-current resistance value of Comparative Example 1. From this result, it was confirmed that the secondary battery according to the present disclosure achieved an increase in closeness of contact between the positive electrode 21 and the positive electrode current collector plate 24 and an increase in closeness of contact between the negative electrode 22 and the negative electrode current collector plate 25, which resulted in favorable joined states and thus made it possible to reduce the internal resistance.

Although the present disclosure has been described hereinabove with reference to an embodiment, the configuration of the present disclosure is not limited thereto, and is therefore modifiable in a variety of ways. For example, in an embodiment, the multiple positive electrode edge parts 212E forming the end face 41 each include the curved face 21RS, and the multiple negative electrode edge parts 222E forming the end face 42 each include the curved face 22RS; however, the present disclosure is not limited thereto. In the present disclosure, for example, only the multiple positive electrode edge parts 212E may each include the curved face 21RS, or only the multiple negative electrode edge parts 222E may each include the curved face 22RS. Alternatively, only some of the multiple positive electrode edge parts 212E may each include the curved face 21RS, or only some of the multiple negative electrode edge parts 222E may each include the curved face 22RS.

Further, in the secondary battery of the present disclosure, the positive electrode and the negative electrode are not necessarily limited to those in the form illustrated in FIGS. 4A and 5A. For example, one or more slits may be provided in the positive electrode exposed region 212 or the negative electrode exposed region 222. Such one or more slits may extend, for example, in the W-axis direction or in a slanting direction with respect to both the W-axis direction and the L-axis direction.

Further, in an embodiment, the description has been given of the case where the electrode reactant is lithium; however, the electrode reactant is not particularly limited. Accordingly, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are merely examples, and the effects of the present disclosure are not limited to those described herein. Accordingly, the present disclosure may achieve other effects.

The present disclosure may encompass the following embodiments.

<1>

A secondary battery including:
an electrode wound body, the electrode wound body including a stacked body that includes a first electrode and a second electrode that are stacked with a separator interposed between the first electrode and the second electrode, the stacked body being wound around a central axis extending in a first direction, the electrode wound body including a first end face and a second end face that are opposed to each other in the first direction;
a first electrode current collector plate facing the first end face of the electrode wound body and coupled to the first electrode; and
a second electrode current collector plate facing the second end face of the electrode wound body and coupled to the second electrode, in which
the first electrode includes a first electrode covered region in which a first electrode current collector is covered with a first electrode active material layer, and a first electrode exposed region in which the first electrode current collector is exposed without being covered with the first electrode active material layer, and
the first electrode exposed region includes multiple first edge parts that are adjacent to each other in a radial direction of the electrode wound body, the multiple first edge parts being bent toward the central axis and overlapping each other to form the first end face, the multiple first edge parts each having an end including a first curved face.
   <2>

The secondary battery according to <1>, in which the end of each of the multiple first edge parts includes a first projection projecting toward a side opposite to the first electrode current collector plate.

<3>

The secondary battery according to <1> or <2>, in which
the second electrode includes a second electrode covered region in which a second electrode current collector is covered with a second electrode active material layer, and a second electrode exposed region in which the second electrode current collector is exposed without being covered with the second electrode active material layer, and the second electrode exposed region includes multiple second edge parts that are adjacent to each other in the radial direction of the electrode wound body, the multiple second edge parts being bent toward the central axis and overlapping each other to form the second end face, the multiple second edge parts each having an end including a second curved face.
   <4>

The secondary battery according to <3>, in which the end of each of the multiple second edge parts includes a second projection projecting toward a side opposite to the second electrode current collector plate.

<5>

The secondary battery according to any one of <1> to <4>, in which the first electrode includes a negative electrode, and the second electrode includes a positive electrode.

<6>

The secondary battery according to any one of <1> to <5>, in which
the second electrode includes a second electrode covered region in which a second electrode current collector is covered with a second electrode active material layer, and a second electrode exposed region in which the second electrode current collector is exposed without being covered with the second electrode active material layer and is joined to the second electrode current collector plate, and
the first electrode current collector includes a copper foil or a copper alloy foil, and the second electrode current collector includes an aluminum foil or an aluminum alloy foil.
   <7>

The secondary battery according to any one of <1> to <6>, in which the first electrode current collector plate and the first end face are joined to each other by welding.

<8>

The secondary battery according to any one of <1> to <7>, in which
the first electrode current collector plate includes nickel, a nickel alloy, copper, a copper alloy, or a composite material of two or more thereof, and
the second electrode current collector plate includes aluminum or an aluminum alloy.
   <9>

The secondary battery according to <6>, in which the second electrode active material layer includes a negative electrode active material, the negative electrode active material including at least one of silicon, silicon oxide, a carbon-silicon compound, or a silicon alloy.

<10>

The secondary battery according to <5>, in which the second electrode active material layer includes a positive electrode active material, the positive electrode active material including at least one of lithium cobalt oxide, lithium nickel cobalt manganese oxide, or lithium nickel cobalt aluminum oxide.

<11>

A battery pack including:
the secondary battery according to any one of <1> to <10>;
a controller configured to control the secondary battery; and
an outer package body that contains the secondary battery.
   <12>
   A method of manufacturing a secondary battery, the method including:
fabricating a first electrode by selectively forming a first electrode active material layer on a first electrode current collector, the first electrode including a first electrode covered region in which the first electrode current collector is covered with the first electrode active material layer, and a first electrode exposed region in which the first electrode current collector is exposed without being covered with the first electrode active material layer, the first electrode covered region and the first electrode exposed region being adjacent to each other in a first direction, the first electrode extending in a second direction orthogonal to the first direction;
forming a cut surface by cutting, along the second direction, the first electrode current collector in the first electrode exposed region, the cut surface including a first curved face and extending in the second direction;
fabricating a second electrode by selectively forming a second electrode active material layer on a second electrode current collector;
fabricating an electrode wound body by
   fabricating a stacked body by stacking the first electrode, a first separator, the second electrode, and a second separator in order, and
   winding the stacked body around a central axis extending in the first direction;
forming a first end face in which multiple first edge parts, of the cut surface of the first electrode having been wound, that are adjacent to each other in a radial direction of the electrode wound body overlap each other, by bending the multiple first edge parts toward the central axis;
joining a first electrode current collector plate to the first end face; and
joining a second end face of the electrode wound body and a second electrode current collector plate to each other, the second end face being on a side opposite to the first end face in the first direction.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an electrode wound body, the electrode wound body including a stacked body that includes a first electrode and a second electrode that are stacked with a separator interposed between the first electrode and the second electrode, the stacked body being wound around a central axis extending in a first direction, the electrode wound body including a first end face and a second end face that are opposed to each other in the first direction;
a first electrode current collector plate facing the first end face of the electrode wound body and coupled to the first electrode; and
a second electrode current collector plate facing the second end face of the electrode wound body and coupled to the second electrode, wherein
the first electrode includes a first electrode covered region in which a first electrode current collector is covered with a first electrode active material layer, and a first electrode exposed region in which the first electrode current collector is exposed without being covered with the first electrode active material layer, and
the first electrode exposed region includes multiple first edge parts that are adjacent to each other in a radial direction of the electrode wound body, the multiple first edge parts being bent toward the central axis and overlapping each other to form the first end face, the multiple first edge parts each having an end including a first curved face.

2. The secondary battery according to claim 1, wherein the end of each of the multiple first edge parts includes a first projection projecting toward a side opposite to the first electrode current collector plate.

3. The secondary battery according to claim 1, wherein
the second electrode includes a second electrode covered region in which a second electrode current collector is covered with a second electrode active material layer, and a second electrode exposed region in which the second electrode current collector is exposed without being covered with the second electrode active material layer, and
the second electrode exposed region includes multiple second edge parts that are adjacent to each other in the radial direction of the electrode wound body, the multiple second edge parts being bent toward the central axis and overlapping each other to form the second end face, the multiple second edge parts each having an end including a second curved face.

4. The secondary battery according to claim 3, wherein the end of each of the multiple second edge parts includes a second projection projecting toward a side opposite to the second electrode current collector plate.

5. The secondary battery according to claim 1, wherein the first electrode comprises a negative electrode, and the second electrode comprises a positive electrode.

6. The secondary battery according to claim 1, wherein according to claim 1, wherein
the second electrode includes a second electrode covered region in which a second electrode current collector is covered with a second electrode active material layer, and a second electrode exposed region in which the second electrode current collector is exposed without being covered with the second electrode active material layer and is joined to the second electrode current collector plate, and
the first electrode current collector comprises a copper foil or a copper alloy foil, and the second electrode current collector comprises an aluminum foil or an aluminum alloy foil.

7. The secondary battery according to claim 1, wherein the first electrode current collector plate and the first end face are joined to each other by welding.

8. The secondary battery according to claim 1, wherein
the first electrode current collector plate includes nickel, a nickel alloy, copper, a copper alloy, or a composite material of two or more thereof, and
the second electrode current collector plate includes aluminum or an aluminum alloy.

9. The secondary battery according to claim 6, wherein the second electrode active material layer includes a negative electrode active material, the negative electrode active material including at least one of silicon, silicon oxide, a carbon-silicon compound, or a silicon alloy.

10. The secondary battery according to claim 5, wherein the second electrode active material layer includes a positive electrode active material, the positive electrode active material including at least one of lithium cobalt oxide, lithium nickel cobalt manganese oxide, or lithium nickel cobalt aluminum oxide.

11. A battery pack comprising:
the secondary battery according to claim 1;
a controller configured to control the secondary battery; and
an outer package body that contains the secondary battery.

12. A method of manufacturing a secondary battery, the method comprising:
fabricating a first electrode by selectively forming a first electrode active material layer on a first electrode current collector, the first electrode including a first electrode covered region in which the first electrode current collector is covered with the first electrode active material layer, and a first electrode exposed region in which the first electrode current collector is exposed without being covered with the first electrode active material layer, the first electrode covered region and the first electrode exposed region being adjacent to each other in a first direction, the first electrode extending in a second direction orthogonal to the first direction;
forming a cut surface by cutting, along the second direction, the first electrode current collector in the first electrode exposed region, the cut surface including a first curved face and extending in the second direction;
fabricating a second electrode by selectively forming a second electrode active material layer on a second electrode current collector;
fabricating an electrode wound body by
fabricating a stacked body by stacking the first electrode, a first separator, the second electrode, and a second separator in order, and
winding the stacked body around a central axis extending in the first direction;
forming a first end face in which multiple first edge parts, of the cut surface of the first electrode having been wound, that are adjacent to each other in a radial direction of the electrode wound body overlap each other, by bending the multiple first edge parts toward the central axis;
joining a first electrode current collector plate to the first end face; and
joining a second end face of the electrode wound body and a second electrode current collector plate to each other, the second end face being on a side opposite to the first end face in the first direction.
